(19) United States
(12) Patent Application Publication
(10) Pub. No.: US 2014/0232643 A1
(43) Pub. Date: Aug. 21, 2014

(54) LASER PROJECTION DEVICE AND METHOD

(71) Applicants: Mohamad Iyad Al Dibs, Pfullingen (DE); Frank Fischer, Gomaringen (DE); Christoph Puttmann, Kusterdingen (DE); David Slogsnat, Tuebingen (DE); Sebastian Reiss, Reutlingen (DE); Daniel Kreye, Reutlingen (DE)

(72) Inventors: Mohamad Iyad Al Dibs, Pfullingen (DE); Frank Fischer, Gomaringen (DE); Christoph Puttmann, Kusterdingen (DE); David Slogsnat, Tuebingen (DE); Sebastian Reiss, Reutlingen (DE); Daniel Kreye, Reutlingen (DE)

(21) Appl. No.: 14/238,907

(22) PCT Filed: Jun. 19, 2012
(86) PCT No.: PCT/EP2012/061658

§ 371 Date: Apr. 21, 2014

(30) Foreign Application Priority Data
Aug. 16, 2011 (DE) 10 2011 081 008.0

(51) Int. Cl. G09G 3/00

(52) U.S. Cl. CPC G09G 3/002
USPC 345/156

(57) ABSTRACT

A laser projection device is described having a projection unit, which is designed to project an image and to generate an interrupt signal as a function of a distance of the projection unit from at least one object located in front of the projection unit in the projection direction, and having an application control unit, which is designed to control the projection unit as a function of the interrupt signal. A method is also described.

### FIELD

The present invention relates to a laser projection device and to a method for projecting image data using a laser projection device.

### BACKGROUND INFORMATION

Projection devices are used today in a plurality of applications to depict moving and non-moving images. For example, projection devices may be fixedly installed in conference rooms or in front of advertising spaces, or the projection devices may be mobile projection devices, which are set up by the particular user just prior to use in front of a corresponding display space or screen.

Projection devices use a light source to be able to project an image. This light source may, for example, be a very bright lamp, e.g., a gas discharge lamp, one or multiple LEDs or a laser light source.

In particular, laser projection devices having a laser light source are suitable for mobile applications, since this laser light source may be set up in a small size and has only little self-heating. In this way simple cooling of the light source becomes possible.

Such laser projection devices are described in European Patent Application No. EP 1117080 (B1), for example.

When a laser projection device having a laser light source is used to project image data, it must be ensured that the intensity of the laser light emitted by the laser light source is controlled in such a way that a risk for people and, e.g., animals, and in particular their eyes, is precluded. For this purpose the laser projection devices detect the distance between an object located in front of the laser projection device and the laser projection device and adjust the intensity of the laser light to the measured distance.

Today this adjustment of the intensity is carried out automatically by a projection unit of a laser projection device. An application processor or an application control unit of the laser projection devices which, for example, transmits the image contents to be projected to the projection unit may poll registers of the projection unit for the content during a polling operation via control lines and data lines and read out the instantaneous intensity of the laser light and the distance between an object located in front of the laser projection device and the laser projection device from the registers. During a polling operation, the application control unit polls the registers of the projection unit at regular intervals and thereupon evaluates their content.

### SUMMARY

The present invention relates a laser projection device and a method.

In accordance with the present invention, an example laser projection device is provided having a projection unit, which is designed to project an image and to generate an interrupt signal as a function of a distance of the projection unit from at least one object located in front of the projection unit in the projection direction, and having an application control unit, which is designed to control the projection unit as a function of the interrupt signal.

An example method is provided for projecting image data using an example laser projection device according to the present invention, including projecting an image with the aid of a projection unit, generating an interrupt signal as a function of a distance of the projection unit from at least one object located in front of the projection unit in the projection direction, and controlling the projection unit as a function of the interrupt signal.

In accordance with the present invention, an energy-saving operation of the laser projection device is possible if an application control unit for detecting objects located in front of the laser projection device does not communicate with the projection unit during a polling operation.

According to the present invention, this is taken into account and an alternative communication option is provided between the application control unit and the projection unit for detecting objects. According to the present invention, the projection unit signals to the application control unit, with the aid of an interrupt signal, that an object is present between the laser projection device and a screen onto which the laser projection device projects an image.

The signaling of the presence of an object with the aid of an interrupt signal offers the advantage that the application control unit no longer has to poll the registers of the projection unit at regular intervals, i.e., no longer has to operate in a resource-intensive polling operation. This considerably reduces the data traffic between the application control unit and the projection unit, and considerably reduces the calculation complexity in the application control unit and the projection unit.

The resources of the application control unit freed up this way may, e.g., be used for calculations for which an additional processor is used in conventional laser projection devices. However, it is also possible to use a simpler application control unit in a laser projection device according to the present invention if no additional calculations are required. This reduces both the complexity of the hardware and software and the costs of a laser projection unit according to the present invention.

Furthermore, it becomes possible to transfer an application control unit of a laser projection device according to the present invention into an idle state, e.g., while the application control unit does not have to carry out any calculations and no interrupt signal is emitted by the projection unit. This is advantageous in particular in mobile applications since the energy consumption of the laser projection device may thus be lowered and, e.g., a battery-operated laser projection device may thus be operated longer with one battery charge.

In one specific example embodiment, the projection unit includes a distance measuring device, which is designed to detect the distance of the projection unit from at least one object located in front of the projection unit in the projection direction. It thus becomes possible to reliably recognize objects located in front of the laser projection device in the projection direction and to respond to the presence of an object in a targeted manner.

In one further specific embodiment, the projection unit further includes a laser scanner device and a laser source which provides a laser light to the laser scanner device, the distance measuring device being designed to detect the distance with the aid of a laser light time of flight measurement and/or a phase difference measurement and/or a time measurement and/or an intensity measurement, and the projection unit being designed to generate the interrupt signal as a function of the detected distance and/or an instantaneous intensity of the laser light provided by the laser source. If the laser light of the laser source is used for distance measuring, a simple distance measurement becomes possible, which does not require any additional components. In one specific embodiment, the distance measurement may be carried out, for example, based on the intensity of the laser light reflected by the projection surface or an object.

In one further specific embodiment, the distance measurement may include an infrared light source and carry out a distance measurement as a function of the time of flight of the infrared light. In further specific embodiments, a distance measurement may, e.g., be carried out with the aid of an ultrasonic distance measurement or the like.

If an interrupt signal is generated as a function of the detected distance and/or an instantaneous intensity of the laser light provided by the laser source, a flexible generation of the interrupt signal is possible. For example, a quotient may be formed of the intensity and distance, and a maximal or minimal value, starting at which an interrupt signal is generated, may be predefined for the quotient.

In one specific embodiment, the projection unit further includes a projection control unit, which is designed to receive the detected distance from the distance measuring device and to generate the interrupt signal and/or to control the laser scanner device and/or the laser source as a function of the instantaneous intensity of the laser light provided by the laser source and/or the detected distance and/or a maximal or minimal threshold value for the instantaneous intensity of the laser light provided by the laser source at the detected distance. If a separate projection control unit is provided, which controls the laser scanner device and/or the laser source and generates the interrupt signal, a modular and flexible design of the laser projection device becomes possible. In this way, a laser projection device according to the present invention may be flexibly adapted to different applications.

In one further specific embodiment, the distance measuring device and/or the projection control unit is/are designed to detect and recognize gestures which a user carries out in front of the projection unit, with the aid of the distance measurement.

In one further specific embodiment, the projection control unit is further designed to control the laser source in such a way that the intensity of the laser light provided by the laser source is automatically increased and/or the intensity of the laser light provided by the laser source is automatically decreased. If the projection control unit automatically adapts the intensity of the laser light, e.g., to the distance between the laser projection device and an object, the intensity of the laser light may be adapted very quickly. For example, if a person steps in front of the laser projection device, protection of the eye of the person, e.g., may thus be ensured. When the person leaves the projection area, the intensity of the laser light may also be increased again very quickly to the level desired for projection, and a high-quality projection may thus be achieved. To be able to adapt the intensity of the laser light, the projection control unit may, e.g., include a look-up table (LUT) in which pairs of distance values and corresponding maximal intensities of the laser light are stored, with the aid of which the projection control unit establishes the intensity of the laser light generated by the laser source.

In one further specific embodiment, the projection control unit is designed to automatically decrease the intensity of the laser light. However, to increase the intensity of the laser light again, the projection control unit is designed to wait for an instruction or a command of the application control unit. For example, the application control unit may poll a user for a confirmation before it issues the instruction to the projection control unit to increase the intensity of the laser light. Therefore a human authority must authorize an increase in the intensity of the laser light.

In one further specific embodiment, the projection control unit is designed in such a way that it does not increase or decrease the intensity of the laser light automatically, but only after having received an instruction or a command from the application control unit. A very flexible adaptation of the intensity of the laser light thus becomes possible since the application control unit may be programmed very flexibly and does not necessarily use an established LUT for determining the intensity.

In one specific embodiment, the projection control unit and the application control unit each have an interrupt interface, via which the projection control unit provides the interrupt signal to the application control unit, the interrupt signal being designed as a latching interrupt signal or a non-latching interrupt signal. If both a latching and a non-latching interrupt signal are provided on the interrupt interface, a very flexible adaptation of the laser projection device to different applications becomes possible. If a latching interrupt signal is emitted by the projection control unit at the interrupt interface, the application control unit may carry out calculations after receipt of the interrupt signal and respond to the interrupt signal, and thereupon give an instruction or a command to the projection control unit to reset the interrupt signal. If the interrupt signal is designed as a non-latching signal, it is possible that the projection control unit issues a second interrupt signal after a first issue of the interrupt signal, if the object further approaches the laser projection device, for example. The application control unit may then interrupt the ongoing calculations and, e.g., adapt them to the new distance of the object from the laser projection unit. This allows a faster response to the changed distance of the object from the laser projection device, but also increases the calculation complexity in the application control unit.

In one further specific embodiment, the projection control unit and the application control unit each have a data interface and a control interface, via which the projection control unit and the application control unit are electrically connected, the application control unit being designed to provide data regarding the image contents to be projected to the projection control unit via the data interface and to control the projection control unit via the control interface and/or to poll the projection control unit for state information. If separate data interfaces and control interfaces for the communication between the projection control unit and the application control unit are provided, very efficient communication becomes possible. For example, the application control unit may provide data regarding the image contents to be projected to the projection control unit via the data interface and, at the same time, access registers of the projection control unit on the control interface.

In one further specific embodiment, the data interface and the control interface may be designed as a single serial or parallel data interface.

In one specific embodiment, the projection control unit is designed as a microcontroller and/or as a program-controlled device and/or as a programmable logical unit and/or as an FPGA and/or as an ASIC. In addition or as an alternative, the application control unit is designed as a microcontroller and/or as a program-controlled device and/or as an application processor and/or as a baseband processor and/or as a graphics processor and/or as a programmable logical unit and/or as an FPGA and/or as a computer and/or as a PC. This allows a flexible design of a laser projection device according to the present invention. Laser projection devices according to the present invention may be designed in such a way that the application control unit is designed as a microcontroller, which decodes or decompresses stored coded or compressed image data and provides these to the projection control unit. As an alternative, a laser projection unit may be provided, in which the projection unit and the application control unit are situated in separate housings. For this purpose, the application control unit may be a commercially available PC, for example. In some specific embodiments, such a commercially available PC includes an interface module which carries out the communication with the projection unit. In further specific embodiments, such a commercially available PC communicates with the projection unit via a standard interface.

In one specific embodiment, the data interface and/or the control interface is/are designed as an MIPI-compliant interface and/or a high-definition multimedia interface (HDMI) and/or a digital visual interface (DVI) and/or a parallel 24-bit interface and/or a serial peripheral interface (SPI) and/or an I²C interface and/or a USB interface and/or an Ethernet interface. In addition or as an alternative, the interrupt interface is designed as a discrete binary active-high interface or a discrete binary active-low interface. If interfaces which correspond to established standards are used, easily available standard components may be resorted to for designing the laser projection device and a cost-effective design of the laser projection device becomes possible.

The above-mentioned embodiments and refinements may be arbitrarily combined with each other, if useful. Further possible embodiments, refinements and implementations of the present invention also include not explicitly described combinations of features of the present invention which are described at the outset or hereafter with respect to the exemplary embodiments. Those skilled in the art will in particular also add individual aspects as improvements or supplements to the particular basic form of the present invention.

### BRIEF DESCRIPTION OF THE DRAWINGS

The present invention is described in greater detail hereafter based on the exemplary embodiments shown in the schematic figures.

FIG. 1 shows a block diagram of one specific embodiment of a laser projection device according to the present invention.

FIG. 2 shows a flow chart of one specific embodiment of a method according to the present invention.

FIG. 3 shows a block diagram of one further specific embodiment of a laser projection device according to the present invention.

FIG. 4 shows a diagram of a signal curve of a latching interrupt signal 10 of one specific embodiment of a projection control unit 2 according to the present invention.

In all figures, identical or functionally equivalent elements and devices were denoted by the same reference numerals, unless indicated otherwise.

### DETAILED DESCRIPTION OF EXAMPLE EMBODIMENTS

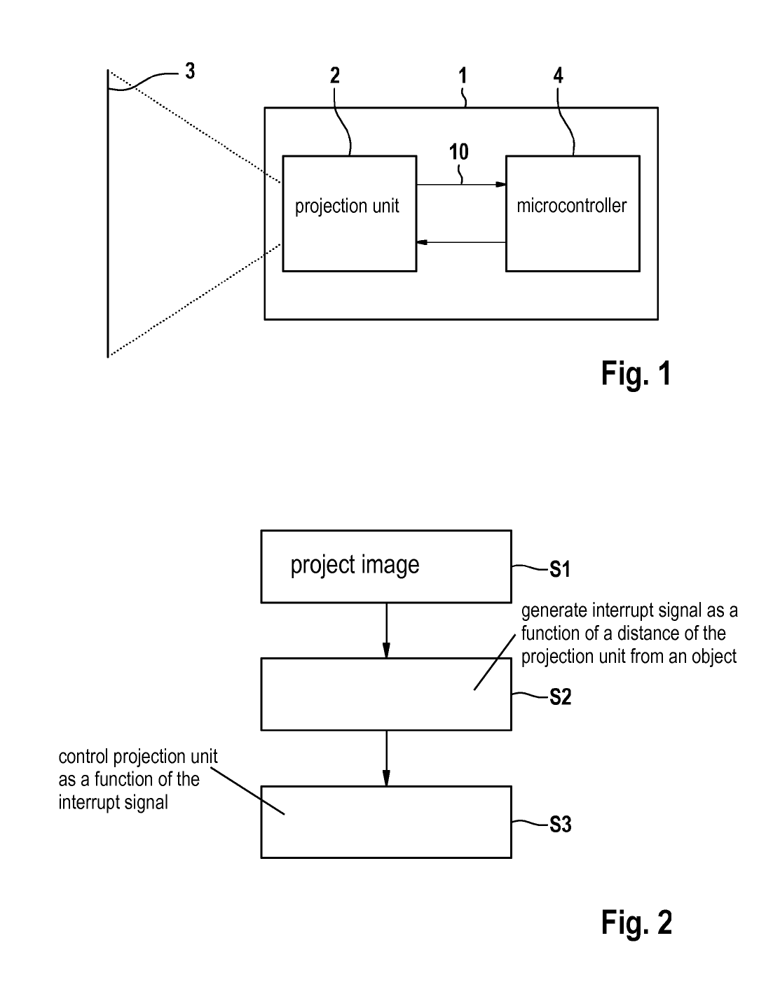

FIG. 1 shows a block diagram of one specific embodiment of a laser projection device 1 according to the present invention.

Laser projection device 1 includes a projection unit 2 which is designed to project an image 3. Laser projection device 1 further includes an application control unit 4, which is designed as a microcontroller 4. Projection unit 2 is further designed to provide an interrupt signal 10 to microcontroller 4, which in FIG. 1 is illustrated as an arrow from projection unit 2 to microcontroller 4. Finally, microcontroller 4 is designed to control projection unit 2, which is illustrated as an arrow from microcontroller 4 to projection unit 2.

In additional specific embodiments, application control unit 4 may not be designed as microcontroller 4, but, e.g., as an FPGA, CPLD, embedded PC or the like.

In laser projection device 1, projection unit 2 detects the distance between an object located in front of projection unit 2 in the projection direction and laser projection device 1 and generates interrupt signal 10 as a function of the detected distance, interrupt signal 10 being provided to microcontroller 4 by projection unit 2.

Microcontroller 4 controls projection unit 2 as a function of interrupt signal 10. After receipt of an interrupt signal 10, microcontroller 4 may, e.g., adapt image contents which it transmits to the projection unit to indicate that an object was recognized.

In additional specific embodiments, a dedicated operating and display device may also be situated in application control unit 4, with the aid of which application control unit 4 displays that an object was recognized.

FIG. 2 shows a flow chart of one specific embodiment of a method according to the present invention.

In a first step S1, an image 3 is projected with the aid of a projection unit 2. In a further step S2, an interrupt signal 10 is generated as a function of a distance of projection unit 2 from at least one object located in front of projection unit 2 in the projection direction. In a final step S3, projection unit 2 is controlled as a function of interrupt signal 10.

When controlling S3 projection unit 2, projection unit 2 may be controlled in such a way that it displays certain image contents, or increases or decreases the intensity of the laser light with which the projection unit projects an image, or in such a way that the register contents of a projection control unit 8 of projection unit 2 are read out and/or changed.

The registers of projection control unit 8 may be registers which include data about a recognized object, such as the distance of the object from the laser projection device, the size of the object, a gesture carried out by the object or the like. Moreover, the registers may include data about the instantaneous intensity of the laser light or other state information about projection unit 2.

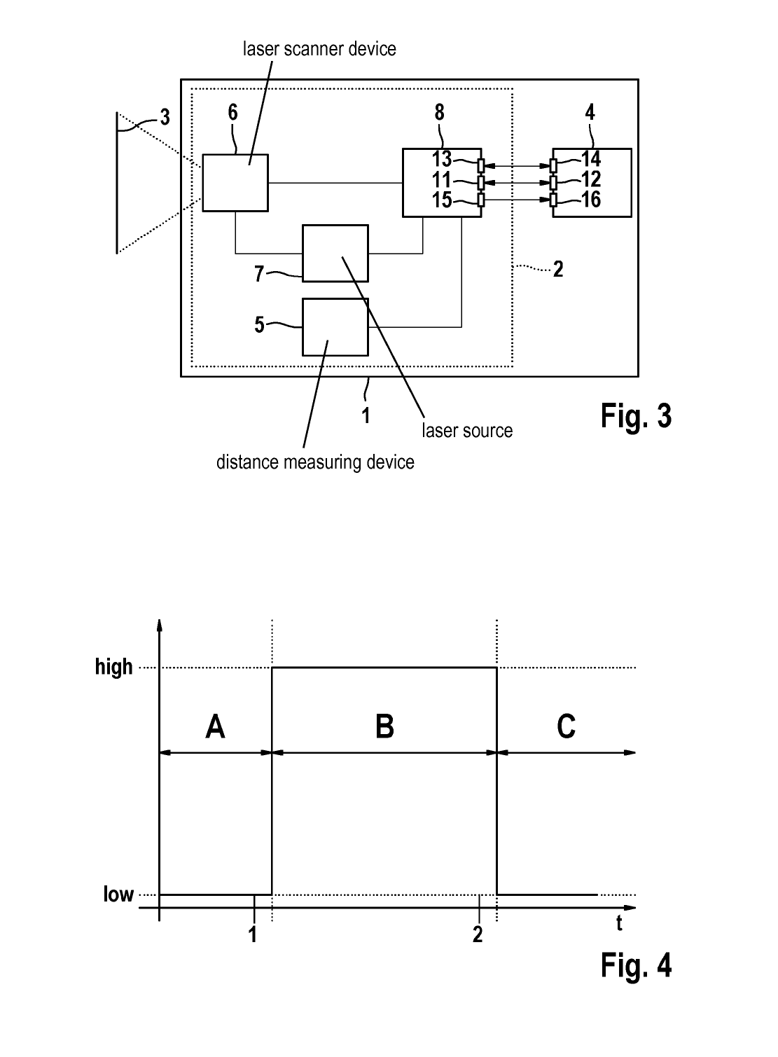

FIG. 3 shows a block diagram of one further specific embodiment of a laser projection device 1 according to the present invention.

Laser projection device 1 from FIG. 3 differs from laser projection device 1 from FIG. 1 to the effect that projection unit 2 includes a distance measuring device 5, which is coupled to projection control unit 8. Projection unit 2 in FIG. 3 further includes a laser scanner device 6 which is coupled to a laser source 7, laser source 7 also being coupled to projection control unit 8. Finally, application control unit 4 and projection control unit 8 each have an interrupt interface 15, 16, a data interface 11, 12 and a control interface 13, 14. The connection between interrupt interfaces 15, 16 is illustrated as a unidirectional connection by an arrow from projection control unit 8 to application control unit 4, the connection between data interfaces 11, 12 is illustrated as a bidirectional connection by an arrow having a tip at each end, and the connection between control interfaces 13, 14 is illustrated as a bidirectional connection also by an arrow having a tip at each end.

In one specific embodiment, laser scanner device 6 and laser source 7 may be designed as one integrated component. In one further specific embodiment, laser source 7 may be designed as an external laser source 7 and connected to laser scanner device 6, e.g., via a light guide.

In the specific embodiment of FIG. 3, projection control unit 8 is designed as an FPGA or ASIC, which is configured to carry out the control of laser source 7 and of laser scanner device 6, to receive a detected distance from distance measuring device 5 and to generate an interrupt signal 10, and to communicate with an application control unit 4.

FIG. 4 shows a diagram of a signal curve of a latching interrupt signal 10 of one specific embodiment of a projection control unit 2 according to the present invention.

In the diagram of FIG. 4, time t is plotted on the x-axis and the logical level, in the form of two states “low” and “high,” of interrupt signal 10 is plotted on the y-axis. The diagram is divided into three time periods A, B and C according to the x-axis. The level of interrupt signal 10 extends at “low” in the first period marked A. A first point in time 1 is plotted on the x-axis just prior to the end of first period A, at which distance measuring device 5 of laser projection device 1 detects an object. Following a brief processing time, which corresponds approximately to one tenth of period A, the level of interrupt signal 10 jumps to “high” and remains at “high” during the entire period B, which is twice as long as period A. A second point in time 2 is plotted on the x-axis just prior to the end of second period B. At this point in time, application control unit 4 has completed its calculations and issues an instruction or a command to projection control unit 8 to release the interrupt and thereby setting the interrupt signal to “low.” Following another brief processing time, which approximately corresponds to the first processing time, the level of interrupt signal 10 jumps back to “low” and remains at this level for the duration of period C. Logic levels “high” and “low” may be implemented as different voltages in different specific embodiments. In one specific embodiment, for example, the “high” level may be a voltage of 5 V and the “low” level may be a voltage of 0 V, or vice versa. In some specific embodiments, voltage ranges may also be provided for the “high” and “low” levels.

While the level of interrupt signal 10 is “high,” i.e., active, for the duration of period B, the application control unit is able, e.g., to read out the registers of projection control unit 8 and control projection control unit 8 based on the read-out information.

Although the present invention has been described above based on preferred exemplary embodiments, it is not limited thereto, but is modifiable in a variety of ways. The present invention may in particular be changed or modified in multiple ways without departing from the core of the present invention.

One specific embodiment of a laser projection device according to the present invention may be used for area monitoring, for example. For this purpose, the projection unit monitors an area with the aid of the distance measurement for the intrusion of moving objects and reports such an intrusion to the application control unit with the aid of an interrupt signal, which thereupon initiates an appropriate response. As long as the projection unit has not detected any intrusion, the application control unit remains in an idle state. Particularly energy-efficient area monitoring thus becomes possible.

In addition, distance monitoring may be carried out with the aid of one specific embodiment of a laser projection device according to the present invention.

In one additional application, an interaction may take place with the laser projection unit with the aid of gesture recognition. For this purpose, the projection unit detects gestures of persons located in front of the laser projection device with the aid of the distance measurement and transmits an interrupt signal to the application control unit when a valid gesture was recognized. The application control unit may then read out the type of the recognized gesture from the registers of the projection control unit and initiate an appropriate response. Once again, the application control unit may remain in an idle state until a gesture is recognized. The present invention is thus suitable in particular for mobile applications which are supplied with electrical energy by batteries.

1-14. (canceled)

15. A laser projection device, comprising:
a projection unit designed to project an image and to generate an interrupt signal as a function of a measurement which allows a conclusion to be drawn of a distance of the projection unit from at least one object located in front of the projection unit in the projection direction; and
an application control unit designed to control the projection unit as a function of the interrupt signal.

16. The laser projection device as recited in claim 15, wherein the projection unit includes a distance measuring device, which is designed to detect the distance of the projection unit from the at least one object located in front of the projection unit in the projection direction.

17. The laser projection device as recited in claim 16, wherein, the projection unit further includes a laser scanner device and a laser source which provides a laser light to the laser scanner device, the distance measuring device being designed to detect the distance with the aid of at least one of: i) a laser light time of flight measurement, ii) a phase difference measurement, iii) a time measurement, and iv) an intensity measurement, and Wherein the projection unit is designed to generate the interrupt signal as a function of at least one of the detected distance, and an instantaneous intensity of the laser light provided by the laser source.

18. The laser projection device as recited in claim 17, wherein the projection unit further includes a projection control unit designed to receive the detected distance from the distance measuring device and to at least one of: i) generate the interrupt signal, ii) control the laser scanner device, and iii) control the laser source, as a function of at least one of: i) the instantaneous intensity of the laser light provided by the laser source, ii) the detected distance, and iii) a maximal or minimal threshold value for the instantaneous intensity of the laser light provided by the laser source at the detected distance.

19. The laser projection device as recited in claim 18, wherein the projection control unit is further designed to control the laser source in such a way that at least one of: i) an intensity of the laser light provided by the laser source is automatically increased, and ii) an intensity of the laser light provided by the laser source is automatically decreased.

20. The laser projection device as recited in claim 15, wherein the projection control unit and the application control unit each have an interrupt interface via which the projection control unit provides the interrupt signal to the application control unit, the interrupt signal being designed as one of a latching interrupt signal or a non-latching interrupt signal.

21. The laser projection device as recited in claim 18, wherein the projection control unit and the application control unit each have a data interface and a control interface via which the projection control unit and the application control unit are electrically connected, the application control unit further being designed to at least one of: i) provide data regarding the image contents to be projected to the projection control unit via the data interface and to control the projection control unit via the control interface, and ii) poll the projection control unit for state information.

22. The laser projection device as recited in claim 21, wherein at least one of:
i) the projection control unit is designed as at least one of: a) a microcontroller, b) a program-controlled device, c) a programmable logical unit, d) an FPGA, and e) an ASK; and
ii) the application control unit is designed as at least of one of: a) a microcontroller, b) a program-controlled device, c) an application processor, d) a baseband processor, e) a graphics processor, f) a programmable logical unit, g) an FPGA, h) a computer, and i) a PC.

23. The laser projection device as recited in claim 21, wherein at least one of: i) the data interface, and ii) the control interface, is designed as at least one of: i) an MIPI-compliant interface, and ii) a high-definition multimedia interface (HDMI), iii) a digital visual interface (DNA), iv) a parallel 24-bit interface, v) a serial peripheral interface (SPI), vi) an I²C interface, vii) a USB interface, and viii) an Ethernet interface.

24. The laser projection device as recited in claim 21, wherein the interrupt interface is designed as one of: i) a discrete binary active-high interface, or ii) a discrete binding active-low interface.

25. A method for projecting image data using a laser projection device, comprising:
projecting an image with the aid of a projection unit;
generating an interrupt signal as a function of a distance of the projection unit from at least one object located in front of the projection unit in the projection direction; and
controlling the projection unit as a function of the interrupt signal.

26. The method as recited in claim 25, wherein the generation of the interrupt signal includes a detection of the distance of the projection unit from at least one object located in front of the projection unit in a projection direction and the generation of an interrupt signal as a function of the detected distance.

27. The method as recited in claim 26, wherein an image is projected with the aid of a laser scanner device and a laser source, and the distance is detected with the aid of a laser light time of flight measurement, the interrupt signal being generated as a function of at least one of the detected distance, or an instantaneous intensity of the laser light provided by the laser source.

28. The method as recited in claim 27, wherein the controlling of the projection unit includes controlling at least one of: the laser scanner device, and the laser source, as a function of at least one of: i) the detected distance, ii) an instantaneous intensity of the laser light provided by the laser source, and iii) a maximal or minimal threshold value for the instantaneous intensity of the laser light provided by the laser source at the detected distance.

29. The method as recited in claim 28, wherein the controlling of at least one of the laser scanner device and the laser source includes at least one of: i) an automatic increase in an intensity of the laser light provided by the laser source, and ii) an automatic decrease in the intensity of the laser light provided by the laser source.
